(19) United States
(12) Patent Application Publication
(10) Pub. No.: US 2014/0204489 A1
(43) Pub. Date: Jul. 24, 2014

(54) Surge Discharge Point for Devices

(71) Applicant: JJS COMMUNICATIONS CO., LTD., Taipei City (TW)

(72) Inventor: SHOU-YING WANG, Taipei City (TW)

(73) Assignee: JJS COMMUNICATIONS CO., LTD., Taipei City (TW)

(21) Appl. No.: 13/768,374

(22) Filed: Feb. 15, 2013

(30) Foreign Application Priority Data
Jan. 23, 2013 (TW) 102201508

(51) Int. Cl. H02H 9/04

(52) U.S. Cl. CPC H02H 9/04
USPC 361/56

(57) ABSTRACT

A surge point discharge device for coupling a signal male connector or female connector comprises a metal body, and a through hole disposed at a center of the metal body for a signal line of the signal male connector or female connector to go through. At least one protruding portion is extended from the metal body for surge point discharging.

### BACKGROUND OF THE INVENTION

1. Field of Invention

The present invention relates to a simple structured and low-cost surge point discharge system for use in devices wherein a single male connector and female connector are joined to a point discharging circuit for protecting downline system equipment, terminal equipment and consumer equipment from being damaged by lightning strikes or other abnormal high voltages that may be carried on transmission lines.

2. Related Art

As electronic systems advance there are a proliferation of high tech consumer electronic devices being used to elevate our living standards, and increase our enjoyment. As networks expand throughout offices and homes, various connectors are commonly used to connect radio frequency transmitting devices, avionics devices and consumer electronic devices to allow for the transmission of signals such as radio-frequency signals, analog signals and video signals.

Coaxial cable is traditionally used as the means of transmitting high frequency signals of video and data. A male connector is needed to connect the cable transmitting signals to consumer electronic devices such as a television via a female connector, the male connecter is disposed at a signal source end and is typically connected to a coaxial cable; the female connector is disposed on an apparatus for receiving signals or a distributor. After the received video signals are transmitted through the male connector and the female connector, the consumer device processes the electronic signals. Briefly, connectors are connecting interfaces between coaxial cables and apparatuses as well as equipment.

Consumer electronic devices are expensive and complicated, and they must be protected from electrical surges. There are many ways currently developed for protecting the electronic products. For instance, some methods include a protection for circuits, whereby a lightning conductor is externally connected in order to prevent the electronic or electrical products from being affected by lighting strikes or abnormal high voltage currents. A conventional lightning conductor is electrically connected between two coaxial cables and is electrically connected to a ground conductor. When the surge protector is affected by an abnormal high voltage current, the electric arc phenomenon will occur rapidly in the internal inert gases to reduce the impedance value of the inert gases to less than 1 ohm in order to make the inert gases become a perfect conductor for conducting the high voltage current to ground After the abnormal high voltage current has passed to ground the inert gases will be returned to a high impedance state.

Even though the conventional lightning conductor can reduce the risk of damage to consumer electric products caused by lighting strikes or abnormal high voltage currents, such a device is expensive and also occupies a lot of space. Therefore, the conventional lightning conductor is not common for use in household electrical appliances.

### SUMMARY OF THE INVENTION

A primary objective of the present invention is to provide a simple-structured and low-cost surge point discharge device by which an electric arc is produced to channel electrical surges from lightning strikes, short circuits or other abmormally high voltages to ground and thus protect consumer electronic equipment from damage.

In order to achieve the above-mentioned objectives, a surge point discharge device is provided by the present invention for use in coupling a signal male connector and female connector. The point discharge device comprises a metal body, and a through hole disposed at a center of the metal body for a signal line to pass through with a plate attached. At least one protruding portion is extended from the metal body for discharging the electric surge.

When the surge point discharge device is embodied, at least one protruding portion is extended from an outer circumference of the metal body for point discharging, and an interval capable of producing a discharging effect is formed between the protruding portion and an inner metal surface of the signal male connector or female connector.

When the surge point discharge device is embodied, the at least one protruding portion is extended from an inner circumference of the metal body towards the through hole for point discharging, and an interval capable of producing a discharging effect is formed between the protruding portion and a metal structure inside the signal male connector or female connector.

When the point discharge device is embodied, the metal body is a ring-shaped metal body.

The present invention will become more fully understood by reference to the following detailed description thereof when read in conjunction with the attached drawings.

### BRIEF DESCRIPTION OF THE DRAWINGS

FIG. 1 is a perspective view of a point discharge device according to an embodiment of the disclosure;

FIG. 2 is a perspective view of the point discharge device being disposed in a distributor female connector according to the embodiment of the disclosure;

FIG. 3 is a perspective view of the point discharge device according to another embodiment of the disclosure;

FIG. 4 is a perspective view of the point discharge device in FIG. 3 being disposed in a female connector;

FIG. 5 is a perspective view of the point discharge device having four protruding portions according to an embodiment of the disclosure;

FIG. 6 is a perspective view of the point discharge device in FIG. 5 being disposed in a male connector;

FIG. 7 is a perspective view of another type of point discharge device according to an embodiment of the disclosure; and

FIGS. 8A to 8C are perspective views of the point discharge device in FIG. 7 being disposed in the male or female connector.

### DETAILED DESCRIPTION OF THE INVENTION

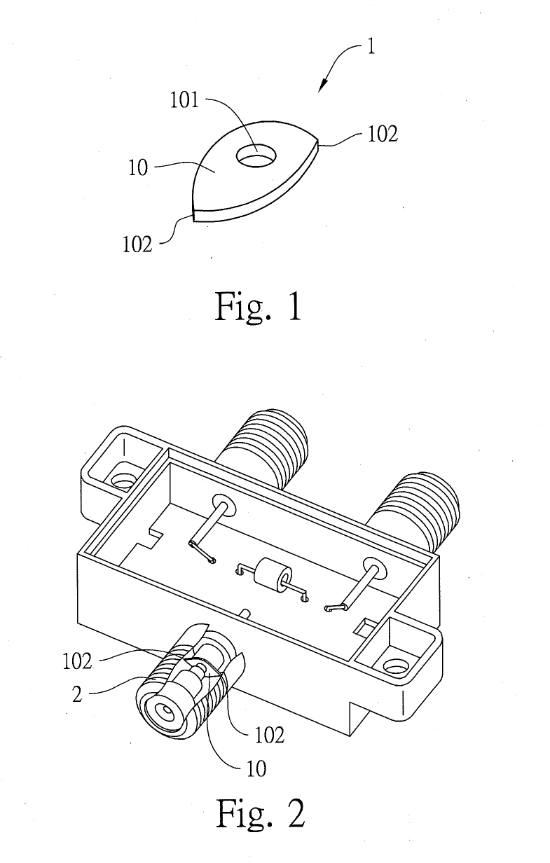

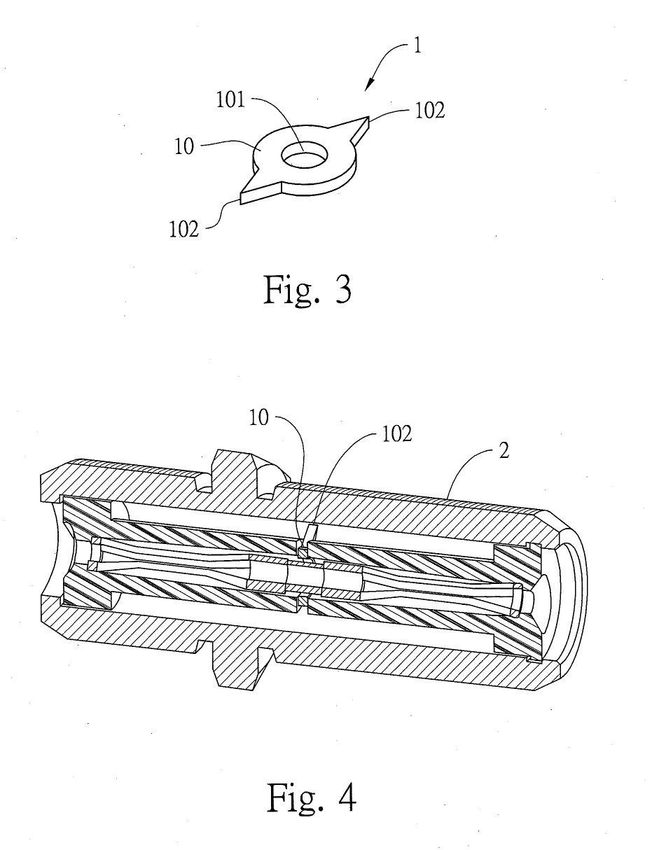

Please refer to FIGS. 1 to 8C, which are related to a point discharge device according to embodiments of the disclosure.

A point discharge device 1 for coupling in a signal male connector 3 or female connector 2 comprises a ring-shaped metal body 10, and a through hole 101 is disposed at the center of the metal body 10 for a signal line of the signal male connector 3 or female connector 2 to go through. At least one protruding portion 102 is extended from the metal body 10 for surge point discharging.

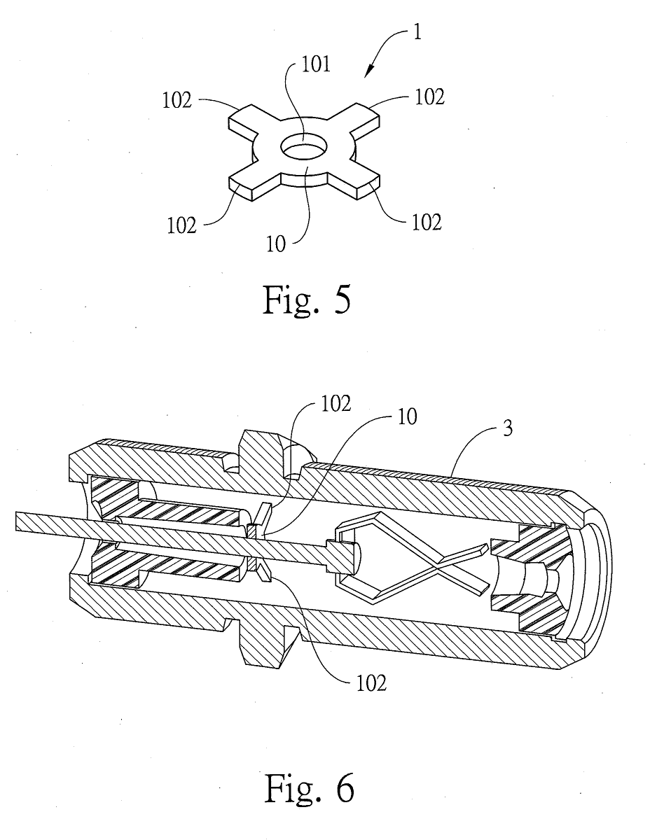

As shown in FIGS. 1 to 6, the at least one protruding portion 102 is extended from an outer circumference of the metal body 10 for point discharging, As shown in FIGS. 1 to 4, two of the protruding portions 102 are extended from two ends of the metal body 10 respectively. When the point discharge device 1 is placed inside the female connector 2, an interval capable of producing a discharging effect is formed between the protruding portions 102 of the metal body 10 of the point discharge device 1 and an inner metal surface of the female connector 2. As shown in FIGS. 5 and 6, four of the protruding portions 102 are extended from the two ends of the metal body 10 respectively. When the point discharge device 1 is placed inside the male connector 3, an interval capable of producing a discharging effect is formed between the protruding portions 102 of the metal body 10 of the point discharge device 1 and an inner metal surface of the male connector 3.

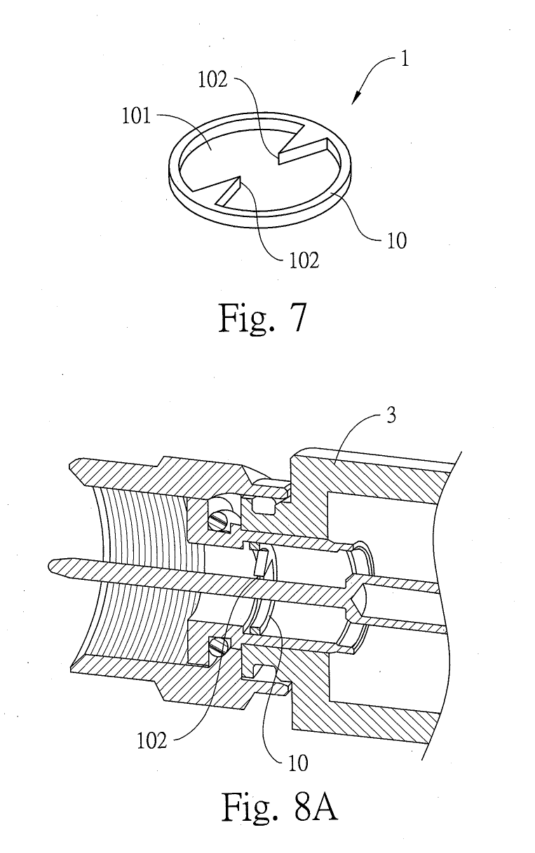

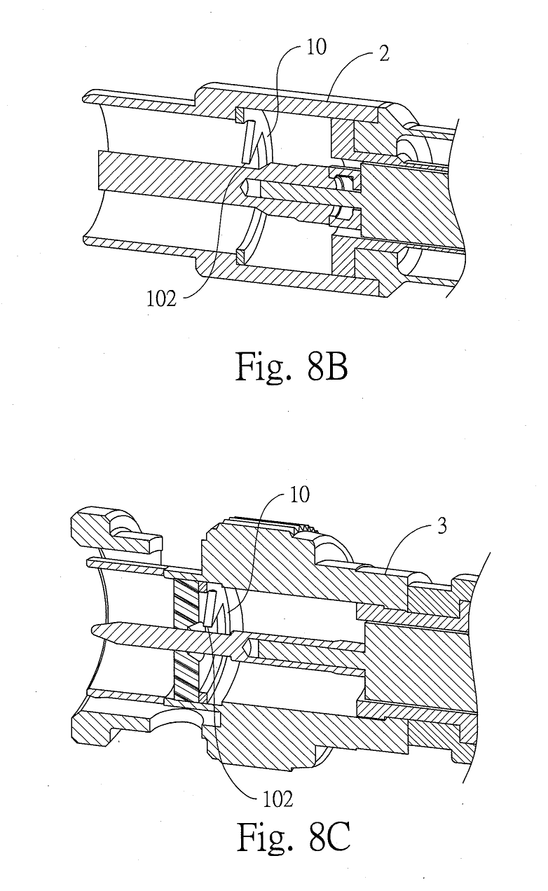

Or, as shown in FIGS. 7 and 8, the protruding portions 102 are extended from an inner circumference of the metal body 10 towards the through hole 101, and an interval capable of producing a discharging effect is formed between the protruding portions 102 and a metal structure inside the signal male connector 3 or the female connector 2.

Therefore, by using the designs of the point discharge device 1, the structure of the point discharge device 1 is not only simple, but can also be manufactured at low cost. Whether the point discharge device 1 is installed in the signal male connector 3 or the female connector 2, the damage to electrical or electronic products can be reduced by the surge discharging effect when lightning strikes or abnormal voltages occur.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A surge point discharge device for coupling with a signal male connector or female connector, comprising:
a metal body, a through hole being disposed at a center of the metal body for a signal line in the signal male connector or female connector to go through, and at least one protruding portion being extended from the metal body for point discharging.

2. The surge point discharge device as claimed in claim 1, wherein the at least one protruding portion is extended from an outer circumference of the metal body for point discharging.

3. The surge point discharge device as claimed in claim 2, wherein an interval capable of producing a discharging effect is formed between the protruding portion and an inner metal surface of the signal male connector or female connector.

4. The surge point discharge device as claimed in claim 1, wherein the at least one protruding portion is extended from an inner circumference of the metal body towards the through hole for point discharging.

5. The surge point discharge device as claimed in claim 4, wherein an interval capable of producing a discharging effect is formed between the protruding portion and a metal structure inside the signal male connector or female connector.

6. The surge point discharge device as claimed in claim 1, wherein the metal body is a ring-shaped metal body.
